(19) United States
(12) Patent Application Publication
(10) Pub. No.: US 2026/0250431 A1
(43) Pub. Date: Aug. 27, 2026

(54) Methods of Forming Halobutyl Elastomers

(71) Applicant: EXXONMOBIL CHEMICAL PATENTS INC., Baytown, TX (US)

(72) Inventors: Simon N. WATSON, Southampton (GB); Peter D. VENTRESS, Southampton (GB); Gavin HUNT, Southampton (GB); Rachel C. HOUNSLOW, Southampton (GB); Christian BRIARD, Barry (GB); Sunny JACOB, Seabrook, TX (US); Stephen T. DALPE, Houston, TX (US)

(21) Appl. No.: 19/139,595

(22) PCT Filed: Aug. 23, 2023
(86) PCT No.: PCT/US2023/072706

§ 371 Date: Jun. 16, 2025

Related U.S. Application Data
(60) Provisional application No. 63/404,584, filed on Sep. 8, 2022.

(51) Int. Cl. C08F 8/22; C08K 5/098; C08K 5/134

(52) U.S. Cl. CPC C08F 8/22; C08K 5/098; C08K 5/134

(57) ABSTRACT

The present disclosure relates to methods of forming halobutyl rubber. In at least one embodiment, a method of forming a halobutyl elastomer includes polymerizing, in a first reactor, a C₄ to C₇ isomonoolefin, and at least one comonomer to obtain a C₄ to C₇ isomonoolefin derived elastomer. The method includes transferring, via a line, the C₄ to C₇ isomonoolefin derived elastomer to a second reactor. The method includes introducing the C₄ to C₇ isomonoolefin derived elastomer with about 20 ppm to about 400 ppm structure III stabilizer, based on the amount of C₄ to C₇ isomonoolefm derived elastomer and structure III stabilizer. The method includes introducing the C₄ to C₇ isomonoolefin derived elastomer with a halogenating agent to form the halobutyl elastomer.

### CROSS-REFERENCE TO RELATED APPLICATION

This application claims priority to and the benefit of U.S. Provisional Patent Application 63/404,584, filed 8 Sep. 2022, entitled METHODS OF FORMING HALOBUTYL ELASTOMERS, the disclosure of which is incorporated herein by reference in its entirety.

### FIELD

The present disclosure relates to methods of forming halobutyl elastomers.

### BACKGROUND

Due to its low gas and vapor permeability, butyl rubber (such as halobutyl elastomer, also referred to as halobutyl rubber) is an important material in the manufacturing of tubeless tires, inner tubes, etc. Butyl rubber is typically manufactured by a slurry polymerization of methylpropene (isobutylene) and 2-methyl-1,3-butadiene (isoprene) in diluent in the presence of an initiator and co-initiator. Halobutyl rubber, such as bromobutyl rubber, is typically formed in a two step process-first is the polymerization of isobutylene and isoprene to produce butyl rubber, which is then followed by halogenation.

Bromobutyl rubber can be described as having different types of monomeric units known as structure 1, structure 2, and structure 3, etc. Structure 1 refers to unbrominated isobutylene units or unbrominated isoprene units. Structure 2 refers to isobutylene units or isoprene units that are brominated at a carbon atom along the polymer backbone (e.g., not at a methyl substituent of isobutylene or isoprene units). Structure 3 refers to isobutylene units or isoprene units that are brominated at a methyl substituent (e.g., not at a carbon atom along the polymer backbone of the isobutylene or isoprene units).

During bromination of the butyl rubber, a bromobutyl rubber can have a high amount of formation of structure 2 units but, over time, the bromobutyl rubber that is formed begins to have undesirably high amounts of structure 3 content, at which point the bromination conditions must be analyzed and altered and/or the bromination is shut down. Ultimately, the bromobutyl rubber having high structure 3 content reduces the yield of bromobutyl rubber having high structure 2 content.

High structure 3 content also results in Mooney viscosity growth (referred to as “marching Mooney”) of the bromobutyl rubber. Mooney viscosity growth can lead to unsatisfactory processability of compound formulations, such as innerline formulations (e.g., for inner tubes).

In addition, bromobutyl rubber manufactured using an in-situ bromine regenerative process for bromination, via the use of hydrogen peroxide, is known to cause increased marching Mooney properties compared to bromination processes that do not utilize bromine regeneration. Increased marching Mooney properties occur during bromine regeneration because bromine regeneration facilitates additional attachment of bromine onto the bromobutyl rubber polymer chain.

There is a need for improved processes for providing halobutyl elastomers having high structure 2 content with improved yields and an option to provide bromine regeneration.

Throughout this specification, “structure 2” is used interchangeably with “structure II”, and “structure 3” is used interchangeably with “structure III”.

References for citing in an information disclosure statement (37 C.F.R. 1.97 (h)): U.S. Pat. Nos. 10,479,845; 4,154,924; 3,257,349; 7,858,735; 4,508,592; Chinese Patent No CN111548436B

### SUMMARY

The present disclosure relates to methods of forming halobutyl elastomer.

In at least one embodiment, a method of forming a halobutyl elastomer includes polymerizing, in a first reactor, a C₄ to C₇ isomonoolefin, and at least one comonomer to obtain a C₄ to C₇ isomonoolefin derived elastomer. The method includes transferring, via a line, the C₄ to C₇ isomonoolefin derived elastomer to a second reactor. The method includes introducing the C₄ to C₇ isomonoolefin derived elastomer with about 20 ppm to about 400 ppm structure III stabilizer, based on the amount of C₄ to C₇ isomonoolefin derived elastomer and structure III stabilizer. The method includes introducing the C₄ to C₇ isomonoolefin derived elastomer with a halogenating agent to form the halobutyl elastomer.

### BRIEF DESCRIPTION OF THE FIGURES

To assist those of ordinary skill in the relevant art in making and using the subject matter hereof, reference is made to the appended figures, wherein:

FIG. 1 is a diagram illustrating butyl rubber formation, according to an embodiment.

FIG. 2 is a diagram illustrating solvent replacement, according to an embodiment.

FIG. 3 is a diagram illustrating halogenation and neutralization of cement to form halobutyl elastomer, according to an embodiment.

FIG. 4 is a diagram illustrating finishing of crumbs, according to an embodiment.

FIG. 5 is a diagram illustrating recycle and recovery of diluent and monomers, according to an embodiment.

FIG. 6 is a graph illustrating BHT versus structure 3 over an Irganox run, according to an embodiment.

FIG. 7 is a graph illustrating BHT versus structure 3 over an Irganox run, according to an embodiment.

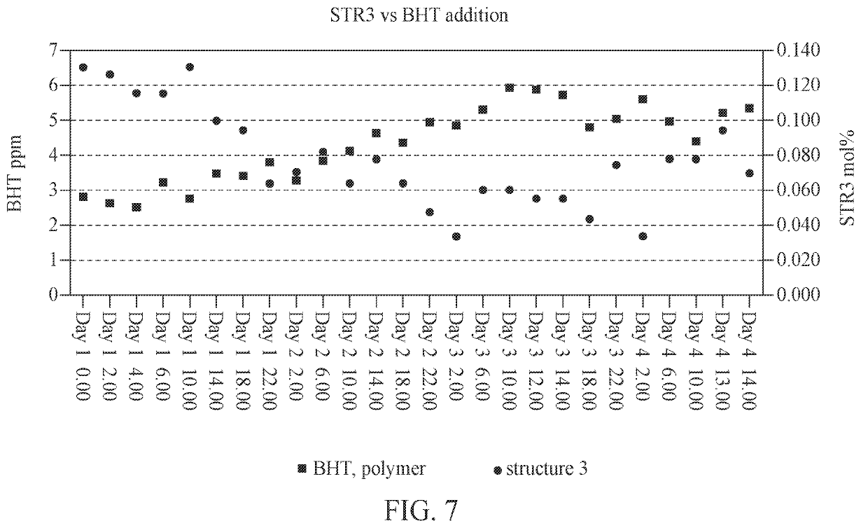

### DETAILED DESCRIPTION

The present disclosure relates to methods of forming halobutyl elastomers.

In some embodiments, a butyl rubber is manufactured by a slurry polymerization of methylpropene (isobutylene) and 2-methyl-1,3-butadiene (isoprene) in methyl chloride diluent in the presence of an initiator and co-initiator. An initiator is HCl and a co-initiator is aluminum chloride or aluminum alkyl, for example, EADC (ethyl aluminum dichloride) or EASC (ethyl aluminum sesquichloride). The butyl copolymer is then quenched using alcohol or water and routed to a processing unit known as the “solvent replacement process” where the polymer is dissolved in a hydrocarbon solvent to make polymer/solvent solution, hereafter known as cement. The cement, diluent, and monomers are then routed to a series of distillation towers where the diluent and monomers are stripped from the cement, the cement is concentrated and the remainder of the hydrocarbon solvent is recovered for recycle. The cement is sent to storage for subsequent halogenation/neutralization, solvent removal, drying and packaging. The diluent monomer stream from the solvent recovery process is dried, compressed and sent to a series of recycle towers to separate the streams. A high purity diluent stream is recycled for catalyst diluent. A diluent/isobutylene stream and an isoprene stream is recovered for a reactor feed blend. Heavies from the process are purged from the unit. Inerts and light ends from the process are purged from the unit.

A structure III stabilizer (such as butylated hydroxytoluene) can be introduced to the halogenation process upstream of the halogenation reactor, which has been discovered to provide halobutyl elastomers having high structure 2 content at a higher yield than conventional processes and provides an option to perform bromine regeneration without marching Mooney. Such structure III stabilizers can be provided upstream of a halogenation reactor (or in the halogenation reactor) in amounts that are less than those of conventional uses of BHT in halobutyl processes.

There are a number of different factors that affect the proportions of structure 2 versus structure 3 formation and one of the most important is having a small quantity of background structure III stabilizer, such as butylated hydroxytoluene (BHT), in the cement. The BHT is generally in the hexane that makes the cement that is halogenated. The BHT source comes from the BHT injected to reslurry. Some of the BHT then follows the hexane that is removed in the flash drums and is recovered back to the main hexane storage tank. The rest of the BHT follows the rubber and ends up in the finished product. However, while making halobutyl rubber using Irganox™ antioxidant for example, BHT is typically not injected into reslurry. BHT levels fall in the hexane tank below a level (typically 3 to 5 days) and then performing runs with the Irganox™ is started. An issue with this approach is that the background BHT levels continue to fall during the Irganox™ run and as this continues structure 3 formation is promoted. The inventors have found that by monitoring levels (e.g., ppm) of BHT in the finished rubber, an amount of structure III stabilizer can be monitored for process control and grading. If BHT levels fall below a desired amount, structure III stabilizer can be introduced upstream of the halogenation reactor, improving yields of desired halobutyl elastomer having high structure 2 content. In other words, the injection of an amount of structure III stabilizer upstream of the halogenation reactor can keep the background levels of BHT/other structure III stabilizer high enough such that structure 3 formation is hindered and provide a halogenated rubber product suitable for pharmaceutical grade specifications. The injection of structure III stabilizer can be performed at any suitable flow rate.

In addition, for halogen regeneration processes, the presence of a structure III stabilizer can additionally provide benefits of reducing or preventing oxidation of halobutyl elastomer product in neutralization units, flash drums, or strippers due to the presence of residual oxidant from emulsion provided to the upstream halogenation reactor. Such oxidation has been shown to negatively affect the control of molecular weight (such as Z-average molecular weight) of halobutyl elastomer products of conventional halogen regeneration processes. While not being bound by theory, when the polymer is subjected to a significant heat change, such as the slurry process following neutralization, the oxidized structures decompose creating polymeric free radicals. Unhindered, the radicals generate in-situ formation of crosslinked networks in the polymer of sufficient quantity to evidence the increase in molecular weight, Mz, and Mooney viscosity.

As used herein, a polymer may be used to refer to homopolymers, copolymers, interpolymers, terpolymers, etc. Likewise, a copolymer may refer to a polymer comprising at least two monomers, optionally with other monomers. When a polymer is referred to as comprising a monomer, the monomer is present in the polymer in the polymerized form of the monomer or in the polymerized form of a derivative from the monomer (i.e., a monomeric unit). However, for ease of reference the phrase comprising the (respective) monomer or the like is used as shorthand. Likewise, when catalyst components are described as comprising neutral stable forms of the components, it is well understood by one skilled in the art, that the ionic form of the component is the form that reacts with the monomers to produce polymers.

Elastomer refers to a polymer or blend of polymers consistent with the ASTM D1566 definition: “a material that is capable of recovering from large deformations, and can be, or already is, modified to a state in which it is essentially insoluble, if vulcanized, (but can swell) in a solvent.” Elastomers are often also referred to as rubbers; the term elastomer may be used herein interchangeably with the term rubber. Elastomers may have a melting point that cannot be measured by Differential Scanning calorimetry (DSC) or if it can be measured by DSC is less than 40° C., such as less than 20° C., such as less than 0° C. Elastomers may have a glass transition temperature (Tg) of −50° C. or less as measured by DSC.

Mooney viscosity or viscosity means the viscosity measure of polymers (e.g., rubbers). It is defined as the shearing torque resisting rotation of a cylindrical metal disk (or rotor) embedded in a polymer within a cylindrical cavity. The dimensions of the shearing disk viscometer, test temperatures, and procedures for determining Mooney viscosity are defined in ASTM D1646. Mooney viscosity is measured in Mooney units and reported herein as ML 1+8 at 125° C.

Isoolefin refers to any olefin monomer having at least one carbon having two substitutions on that carbon. Multiolefin refers to any monomer having two or more double bonds. In a preferred embodiment, the multiolefin is any monomer comprising two conjugated double bonds such as a conjugated diene like isoprene.

Isobutylene based elastomer or polymer refers to elastomers or polymers comprising at least 70 mol % isobutylene units.

### Elastomer

Elastomeric polymers (e.g., rubbers) of the present disclosure include elastomers derived from a mixture of monomers, the mixture of monomers having at least (1) a C₄ to C₇ isoolefin monomer component with (2) at least one multiolefin or other polymerizable monomer component. The isoolefin can be present in a range of 70 to 99.5 wt % by weight of the total monomers, such as 85 to 99.5 wt %. The multiolefin derived or other polymerizable monomer component is present in amounts of about 30 wt % to about 0.5 wt %, or about 15 wt % to about 0.5 wt %, or about 8 wt % to about 0.5 wt %.

The isoolefin can be a C₄ to C₇ compound, non-limiting examples of which are compounds such as isobutylene, isobutene, 2-methyl-1-butene, 3-methyl-1-butene, 2-methyl-2-butene, 1-butene, 2-butene, methyl vinyl ether, indene, vinyltrimethylsilane, hexene, and 4-methyl-1-pentene. The multiolefin can be a C₄ to C₁₄ multiolefin such as isoprene, butadiene, 2,3-dimethyl-1,3-butadiene, myrcene, 6,6-dimethyl-fulvene, hexadiene, cyclopentadiene, and piperylene. Other polymerizable monomers such as styrene and dichlorostyrene are also suitable for homopolymerization or copolymerization in butyl rubbers.

Elastomers can include isobutylene-based copolymers. As stated above, an isobutylene based polymer refers to a polymer (e.g., elastomer) having at least 70 mol % repeat units from isobutylene and at least one other polymerizable unit. These polymers are also conventionally referred to as butyl rubbers. In some embodiments, butyl rubber is obtained by reacting isobutylene with 0.5 to 8 wt % isoprene, or reacting isobutylene with 0.5 wt % to 5.0 wt % isoprene—the remaining weight percent of the polymer being derived from isobutylene.

Other elastomeric polymers of the present disclosure can be derived from at least one random copolymer comprising a C₄ to C₇ isoolefin and an alkylstyrene comonomer. The isoolefin may be selected from any of the above listed C₄ to C₇ isoolefin monomers, and can be an isomonoolefin, and may be isobutylene. The alkylstyrene may be para-methylstyrene, containing at least 80%, such as at least 90%, such as at least 95%, by weight of the para-isomer and can also include functionalized terpolymers. The random copolymer has at least one or more of the alkyl substituents groups present in the styrene monomer units. In some embodiments, the elastomer comprises random polymers of isobutylene and 0.5 to 20 mol % para-methylstyrene.

In some embodiments, other useful elastomers include other unsaturated copolymers of isoolefins. Non-limiting examples of such unsaturated polymers are poly(isobutylene-co-butadiene), star-branched isobutylene-isoprene, star-branched isobutylene-p-methylstyrene, isobutylene-isoprene-alkylstyrene block polymers and random polymers of isobutylene-isoprene-alkylstyrene.

In some embodiments, a halobutyl elastomer (halobutyl rubber) of the present disclosure can have about 0.1 mol % to about 3 mol % of isoprene (brominated+unbrominated), such as about 0.5 mol % to about 3 mol %, such as about 1.5 mol % to about 1.8 mol %, such as about 1.6 mol % to about 1.7 mol %, based on the total moles of monomeric units (e.g., isoprene (brominated+unbrominated)+isobutylene). A halobutyl elastomer (halobutyl rubber) of the present disclosure may have about 0.6 mol % to about 1.1 mol % structure II units, such as about 0.6 mol % to about 0.9 mol %, such as about 0.7 mol % to about 0.9 mol %, based on the total moles of monomeric units. A halobutyl elastomer (halobutyl rubber) of the present disclosure may have about 0.01 mol % to about 0.15 mol % structure III units, such as about 0.03 mol % to about 0.15 mol %, such as about 0.07 mol % to about 0.1 mol %, based on the total moles of monomeric units.

In some embodiments, a halobutyl elastomer (halobutyl rubber) of the present disclosure can have about 20 ppm or less of structure III stabilizer content, such as about 15 ppm or less, such as about 10 ppm or less, such as about 7 ppm or less.

### Butyl Rubber Processes

The above polymers may be produced by any suitable polymerization. The polymers can be produced in either a slurry polymerization process or a solution polymerization process. If the polymer is produced in a slurry polymerization process where the polymer precipitates out of the reaction medium, then the polymer is dissolved into a suitable solvent, e.g., the creation of a polymer cement, prior to halogenation. For polymers produced via a solution process, after removal of unreacted monomers and removal or neutralization of unused catalysts, the same polymer containing solution, or polymer cement, may be used for halogenation. The polymer cement can contain about 1 wt % to about 70 wt % polymer, such as about 10 wt % to about 60 wt % polymer, such as about 10 wt % to about 50 wt % polymer, such as about 10 wt % to about 40 wt % polymer.

### Monomer Preparation

High purity isobutylene (typically about 95 wt % to about 100 wt %) and isoprene (such as about 95 wt % to about 99.9 wt %) can be used for the manufacture of butyl rubber. Impurities can have an impact on isobutylene/isoprene conversion, polymer molecular weight distribution, and reactor performance. The monomer purity is controlled by purchase specifications and stringent quality control with additional purification completed at the production unit if desired. High purity isobutylene can be derived from fossil fuels, advanced recycling processes, or bio based sources.

### Catalyst Preparation

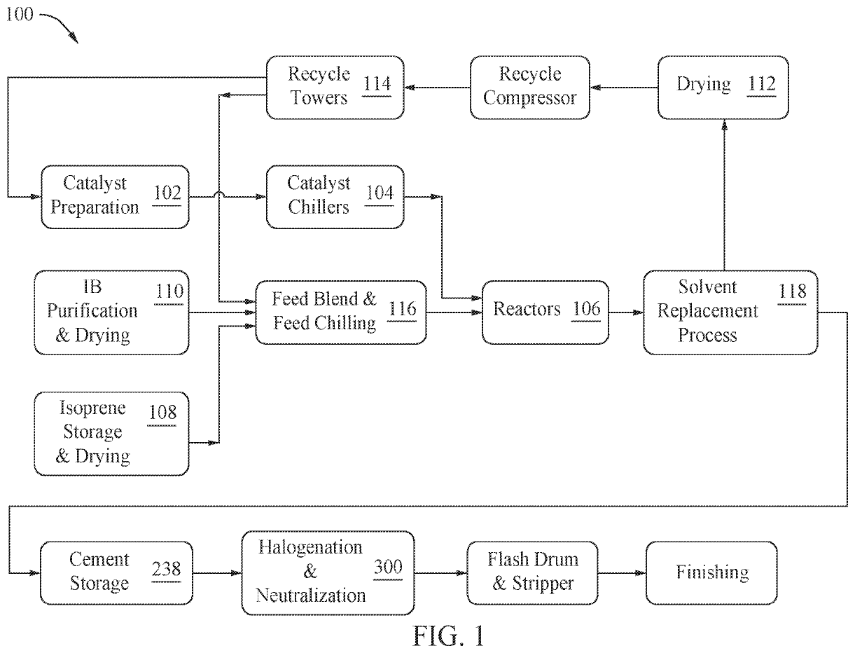

The high purity diluent (typically about 98 wt % to about 100 wt %) used for catalyst diluent from a diluent recovery tower is combined with the initiator and then the catalyst. The initiator is typically HCl, the catalyst is typically either aluminum alkyl catalyst or aluminum chloride catalyst. FIG. 1 is a diagram 100 illustrating butyl rubber formation. When an aluminum alkyl catalyst is used, the catalyst diluent and catalyst are combined at 102 and mixed with static mixers to ensure good distribution. When aluminum chloride catalyst is used, the catalyst diluent stream is split and one portion of the catalyst diluent is chilled at 102 and sent through aluminum chloride dissolving bed(s) and subsequently recombined with the other portion of the catalyst diluent to achieve the desired catalyst concentration. The catalyst/diluent/initiator stream is injected into the reactor(s) 106 at a high velocity to ensure good distribution in the reactor, such as about 1.5 m/s to about 5 m/s. The catalyst to initiator ratio can be about 1 mol/mol to about 5 mol/mol, such as about 1.5 to about 2.5 mol/mol.

The reaction is sensitive to oxygenated compounds, oxygen and moisture. Moisture is removed from fresh isoprene at 108 and isobutylene at 110 before being sent to the reactor 106. The diluent/monomer recycle stream is dried at 112 with fixed bed alumina and/or molecular sieve driers to remove residual moisture and oxygenated compounds. The recycled solvent stream is dried at 114 with fixed bed molecular sieve driers or by fractionation before reuse in the process. The recycle streams and raw material streams are fitted with moisture analyzers, oxygen analyzers, and oxygenate analyzers to assure moisture, oxygen and oxygenate levels are controlled. Light ends including oxygen are purged from the diluent recovery tower distillate drum.

### Feed Blend and Reactors

Isobutylene and isoprene in diluent are prepared to a predetermined composition in a feed blend drum at 116, chilled to −90° C. to −100° C. using a series of heat exchangers and fed to reactor(s) 106. A catalyst and co-catalyst are prepared in high purity diluent and fed to the reactor(s) 106. A copolymer of isobutylene and isoprene is made in the reactor(s) 106. An example diluent used is methyl chloride. In some embodiments, the feed blend contains about 20 wt % to about 40 wt % isobutylene and about 0.4 wt % to about 1.4 wt % isoprene depending on the grade with the remainder being mainly diluent.

Butyl reactors foul with time and are taken out of service periodically to be cleaned. The butyl reaction process can thus be a semi batch process with a number of reactors producing and a number of reactors in non-production mode. At the end of the production cycle the producing reactor is quenched by injecting alcohol or water into the reactor to stop the reaction and then flushed with diluent at a temperature of about −40° C. to −80° C. to remove the bulk of the rubber slurry and gradually warm the reactor. Solvent is introduced to further warm the reactor up to 0° C. to 50° C. The reactor 106 is then washed with solvent at a temperature of 0° C. to 90° C. to remove the rubber foulant that has accumulated on the vessel surface. When the reactor 106 is clean, the solvent is displaced with diluent at −40° C. to −80° C. to gradually cool the reactor down and then chilled down to −90° C. to −100° C. in preparation for production. The flowrates, temperatures, and duration of each of the non-production stages are managed to ensure the mechanical design conditions of the reactor and reactor pump are not compromised.

When the reactor 106 is chilled for production, the reactor 106 is primed with a mixture of diluent, isobutylene, and isoprene. The diluent isobutylene and isoprene concentrations are set to emulate the normal background concentrations during reactor production to ensure the polymer is quickly at specification. The initiator and co-initiator are then injected at high rates to ensure the reaction initiates rapidly before being set to normal rates to assure the rubber is at specification.

### Solvent Replacement Process

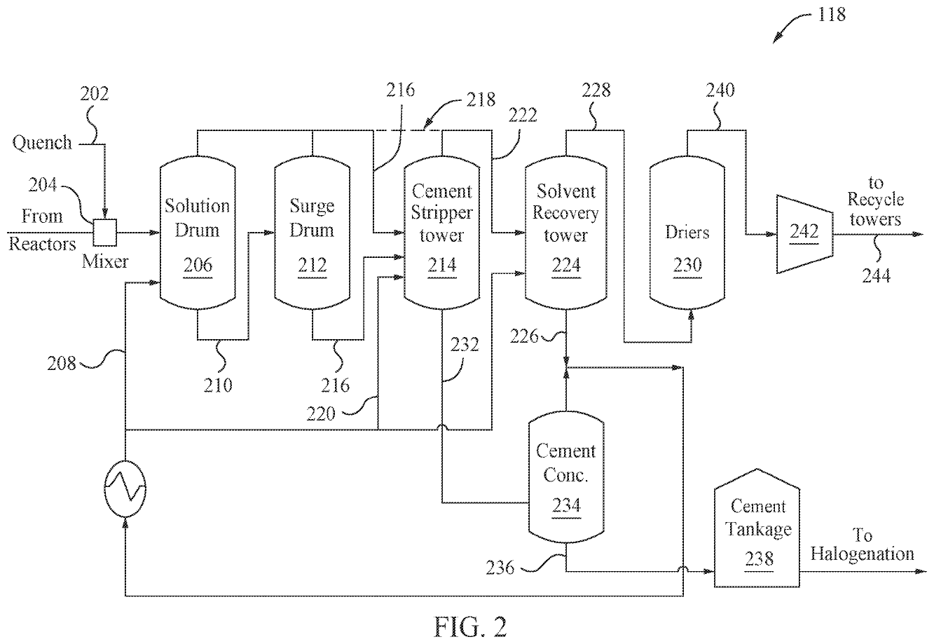

An alcohol or water quench is injected into the reactor overflow outlet to quench the catalyst at 118, e.g., as described in U.S. Pat. No. 4,154,924 incorporated by reference herein. FIG. 2 is a diagram illustrating solvent replacement 118. As shown in FIG. 2, quench 202 may be premixed with polar diluent and may then be diluted with solvent, with or without a static mixer, before adding to the reactor outlet. The quench 202 is injected and mixed at 204 with the reactor slurry with or without a mechanical mixer. The resulting stream is then routed to a solution drum 206 where solvent vapor 208 is added to heat the process and dissolve the polymer to make a polymer/solvent solution known as cement. A typical solvent is a mixture of normal hexane and isomers of hexane. The solution drum liquid outlet 210 is then routed to a surge drum 212. The solution drum 206 and surge drum 212 may be combined into a single drum. The solution may be sampled and analyzed periodically to monitor polymer properties. Statistical Process Control techniques and fundamental or empirical models may be used to monitor product quality and guide optimization of polymerization conditions. The drum(s) operating temperatures can be about −20° C. to about +30° C., such as about −20° C. to about +10° C. and the operating pressures can be about 0 kPag to about1000 kPag, such as about 0 kPag to about 500 kPag. The process is operated to generate a vapor stream of about 0% to about 30% of the total drum feed, e.g., as described in U.S. Pat. No. 3,257,349 incorporated by reference herein. The liquid stream from these drums having cement/solvent/diluent/unreacted monomers is routed to a cement stripping tower 214 via line 216. The vapor stream having solvent/diluent/unreacted monomers from the drums 206 and 212 is routed to either the cement stripping tower 214 via line 216 or the cement stripping tower overheads via line 218. The cement stripping tower 214 is a 20-60, such as 40-60, dual flow tray suitable for fouling service, for example the TECHNIP RIPPLE TRAY™ tower, e.g., as described in U.S. Pat. No. 3,257,349. Solvent vapor is injected at the bottom of the tower via line 220 and flows counter currently to the cement. The cement stripping tower overheads having diluent, unreacted monomers, and a portion of the solvent is routed via line 222 to a solvent recovery tower 224 where high purity solvent is recovered in the bottoms stream (line 226) for recycle and diluent, unreacted monomers are recovered in the overheads (line 228) and sent to the diluent recycle stream driers 230.

The cement stripping tower 214 is operated to ensure that the monomer concentration is very low in the cement stream as any monomers could react in subsequent halogenation processes and exceed desired product specifications (e.g., Industrial Hygiene control). The monomer concentration in the cement stream (line 232) is <200 wtppm and typically <50 wtppm for good industrial hygiene control.

The bottoms cement stream (line 232) from the cement stripping tower 214 is flashed into 1-2 cement concentrator drums 234. The cement is cooled and the cement concentration increased. The cement concentrator overheads vapor stream (line 234) has a temperature that is determined by the utilities temperature, typically cooling water or air. The operating pressure of the concentrator drum(s) 234 is determined by the solvent vapor pressure curve, the typical solvent is a mixture of normal hexane and isomers of hexane. The cement concentrator(s) 234 are operated at a pressures of about 40 kPaa to about 150 kPaa, such as about 50 kPaa to about 100 kPaa, e.g., as described in U.S. Pat. No. 3,257,349. The cement concentrator drum 234 is fitted with side to side trays or baffle plates (shower deck) that allow the solvent vapor to separate from the viscous cement and minimize vapor entrainment in the bottoms cement stream (line 236). The overheads solvent from the cement concentrator is recycled in the process. The bottoms cement stream (line 236) is sent to storage 238. The cement concentration sent to storage 238 is about 18 wt % to about 30 wt %, such as about 22 wt % to about 28 wt %. Heat integration is used extensively in the solvent recovery part of the plant and the reslurry part of the unit to maximize energy efficiency.

### Halogenation and Neutralization

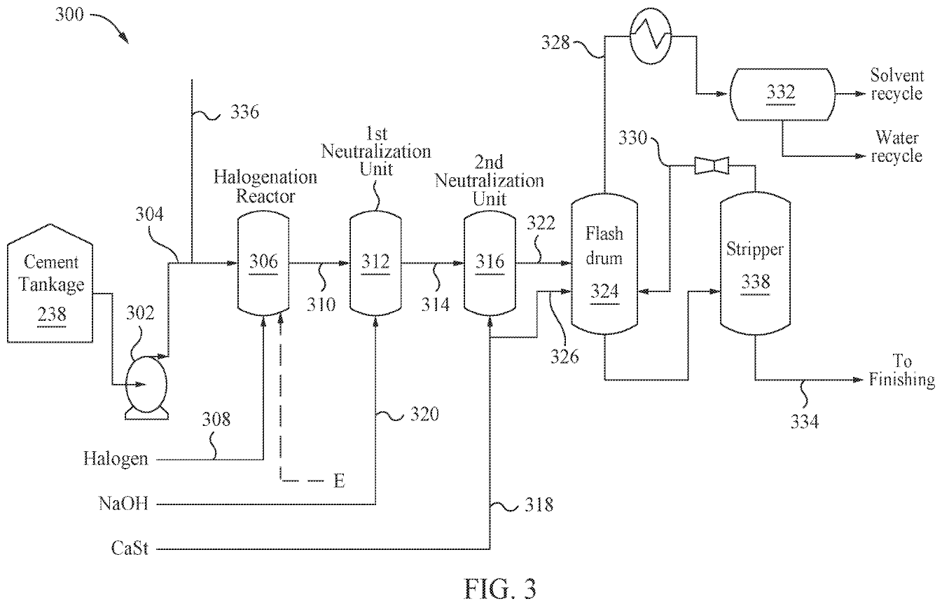

Halogenation and neutralization can be performed using any suitable process. FIG. 3 is a diagram 300 illustrating halogenation and neutralization of cement to form halobutyl rubber. As shown in FIG. 3, the cement from storage 238 is pumped via pump 302 and line 304 to a well-mixed halogenation reactor 306 where halogen (e.g., Br₂, Cl₂, NaBr, NaCl, or combinations thereof) is added via line 308 to form halobutyl rubber. The halogen can be vapor chlorine or liquid bromine depending on the grade of halobutyl being made. The halogenation reactor 306 can be a CSTR (continuous stirred tank reactor) or a high speed mixing device such as a CONTACTOR™ from STRATCO™. In some embodiments, reactor vessel is a mixed flow stirred tank, a conventional stirred tank, a packed tower, or a pipe with sufficient flow and residence time to permit the desired reaction to occur. Additional pipework and valves may be included downstream to control reaction residence time. Structure III stabilizer is introduced at any suitable portion of halogenation process, such as cement tank 238, pump 302, halogenation reactor 306, or (as shown in FIG. 3) at line 304 via line 336.

The halogenated cement and reaction by-products (line 310) are then mixed with a neutralizing agent (such as sodium hydroxide) (line 320) in first neutralization unit 312 to neutralize the resultant HCl or HBr/bromine. The first neutralization stage may be 1-4 individual process units and may be a CSTR, a CONTACTOR™, a static mixer, or a combination thereof. The stream (line 314) from the first neutralization unit 312 is then mixed with an additive in second neutralization unit 316 to complete neutralization and to form a stable emulsion. The additive is typically calcium stearate dispersion with a surfactant (line 318). In some embodiments, a surfactant is a non-ionic alcohol ethoxylate, such as ethoxy tridecyl alcohol. The second stage neutralization process unit may be 1-4 individual process units and may be a CSTR, a CONTACTOR™, a static mixer, or a combination thereof.

The water/hydrocarbon emulsion from the halogenation and neutralization section (line 322) is routed to flash drum 324 and stripper 338 vessels to remove and recover the solvent (line 328). The water/hydrocarbon emulsion is flashed into an agitated flash drum 324 where steam is injected into the liquid to strip the solvent from the stream. A rubber crumb is formed in the flash drum 324, an additive (line 326) is added to the flash drum 324 to prevent polymer agglomeration and vessel plugging. The additive is typically calcium stearate dispersion with a surfactant. The water/crumb mixture flows to an agitated stripper 338 where additional residence time and reduced pressure allows the solvent to diffuse from the crumb to the vapor stream (line 330). Additional steam may be injected into the stripper 338 to aid the solvent diffusion process. Water is sprayed into the vapor space of the flash drum 324 and the vapor space of the stripper 338 to reduce vessel fouling and provide cooling, the spray pattern is typically either hollow cone or solid cone. The slurry concentration to the flash drum 324 and stripper 338 process units is controlled to minimize agglomeration and the propensity for plugging by, for example, controlling flow rates of the calcium and surfactant injected into the flash drums to manage the crumb size within a desirable operational parameter. Lower injection rate provides higher crumb size and vice versa

The solvent/water in the vapor streams (line 328) from the flash drums is condensed and the solvent separated in a condenser/separator 332 and sent to storage for subsequent drying and recycle, the water is recycled in the process.

During halobutyl production, the cement temperature to halogenation is controlled to less than 65° C., such as 20° C. to 65° C., or 40° C. to 60° C., to ensure favorable reaction to meet final product cure properties.

Flash drum 324 is operated at a pressure of about 140 kPaa to about 190 kPaa, and the liquid temperature is about 105° C. to about 120° C. The stripper 338 pressure can operate at a pressure of about 80 kPaa to about 130 kPaa, such as about 90 kPaa to about 120 kPaa, and the liquid temperature is about 90° C. to about 110° C. The stripper 338 pressure is controlled by vacuum pumps or vacuum jets. The stripper overheads stream (line 330) is recycled to the flash drum(s) 324 for energy conservation. In larger production facilities multiple flash drum(s) and stripper(s) may be operated in parallel. In facilities where parallel flash drum(s) and stripper(s) are employed, instrumentation can be used to ensure even flow distribution between the parallel units.

Flash drum 324 can have agitators to ensure good mixing between cement and water and to promote crumb formation such as eccentric flat blade agitators. Stripper 338 agitators to ensure good mixing of floating rubber particles in liquid include up or down pumping pitched blade turbines, up or downpumping hydrofoils.

The crumb size can be controlled in the flash drum 324 and stripper 338, because too small crumbs results in vessel and pipework fouling and difficulty dewatering/drying, whereas too large crumbs makes solvent removal difficult and may result in pipework plugging. Crumb size is controlled by calcium stearate addition, calcium stearate particle size and particle size distribution, and surfactants added with the calcium stearate. Crumb size distribution is measured and monitored, e.g., depending on downstream processing such as extruder sizing.

In some embodiments of a halogenation process, isobutylene-based polymers having unsaturation in the polymer backbone, such as isobutylene-isoprene polymers, may be halogenated using an ionic mechanism during contact of the polymer with a halogen source, e.g., molecular bromine or chlorine, and at temperatures of from about 20° C. to 80° C. Isobutylene based polymers having no unsaturation in the polymer backbone, such as isobutylene-alkylstyrene polymers, can undergo halogenation under free radical halogenation conditions, e.g., in the presence of white actinic light or by inclusion of an organic free radical initiator in the reaction mixture, and at temperatures of 20° C. to 90° C.

In some embodiments, a halogenation process of the present disclosure is a regenerative halogenation process. Conventional regenerative halogenation processes can occur by contacting a polymer solution with a halogenating agent and an emulsion containing an oxidizing agent. The oxidizing agent interacts with hydrogen halide created during halogenation, converting the halogen back into a form useful for further halogenation of the polymer thereby improving the halogen utilization.

For regenerative halogenation, an emulsion is fed per feedstream E into the halogenation reactor 306. The emulsion includes the oxidizing agent, water, solvent, and an emulsifying agent, such as a surfactant. The emulsion is prepared by providing ab about 10 wt % to about 80 wt %, such as a 20 wt % to about 70 wt % or about 25 to about 45 wt %, solution of the oxidizing agent in water and mixing this with a solvent and an emulsifying agent under suitable mixing conditions to form a stable emulsion. The emulsion may be achieved by mixing the aqueous phase into the emulsifying agent containing solvent, or by mixing the oxidizing agent with the emulsifying agent first and then combining with the solvent. The amount of oxidizing agent can be about 0.1 to 3, such as about 0.25 to about 3, such as about 0.5 to about 3 moles of active oxidizing agent per mole of halogenating agent. Use of an oxidizing agent during bromination increases bromine utilization to about 70 to 85%.

Oxidizing agents useful in a process of the present disclosure are materials which contain oxygen, such as water soluble oxygen containing agents. Suitable agents include peroxides and peroxide forming substances such as hydrogen peroxide, organic hydrogen peroxide, sodium chlorate, sodium bromate, sodium hypochlorite or bromite, oxygen, oxides of nitrogen, ozone, urea peroxidate, acids such as pertitanic perzirconic, perchromic, permolybdic, pertungstic, perunanic, perboric, perphosphoric, perpyrophosphoric, persulfates, perchloric, perchlorate and periodic acids. Of the foregoing, hydrogen peroxide and hydrogen peroxide-forming compounds, e.g., per-acids and sodium peroxide, have been found to be highly suitable for carrying out halogen regeneration.

The choice of solvent for the emulsion may be any solvent suitable for use or used in forming the polymer cement. In one embodiment, the solvent is selected to be the same solvent used to form the polymer cement. Suitable solvents include hydrocarbons such as pentane, hexane, heptane, and the like, inert halogen containing hydrocarbons such as mono-, di-, or tri-halogenated C₁ to C₆ paraffinic hydrocarbon or a halogenated aromatic hydrocarbon such as methyl chloride, methylene chloride, ethyl chloride, ethyl bromide, dichloroethane, n-butyl chloride, and monochlorobenzene or mixtures of the hydrocarbon and inert halo-hydrocarbon solvent. Furthermore, the solvent may be a combination of the solvents provided herein, including isomers thereof.

The emulsion fed via feedstream E may be introduced into the halogenation reactor 306 at the beginning of the halogenation cycle or after consumption of the halogen via halogenation of the polymer has begun. The halogenation reaction and the halogen regeneration reaction can occur at a temperature of about 20° C. to about 90° C. for a time sufficient to complete halogenation of the polymer. When molecular bromine is the halogenating agent introduced via feed stream (line) 308, bromine consumption is indicated by a color change of the reaction mixture from a reddish brown to a light tan or amber color. Following sufficient reaction time in the halogenation reactor 306, the effluent, via line 310, exiting the halogenation reactor 306, is neutralized, e.g., as described above.

### Structure III Stabilizers

A free-radical stabilizer, free-radical scavenger, or antioxidant, collectively referred to herein as a “structure III stabilizer”, is provided at a location upstream of the halogenation reactor. The structure III stabilizer may be organic-soluble or a water compatible compound, such as an oil-soluble compound or a hexane-soluble compound.

Suitable structure III stabilizers include sterically hindered nitroxyl ethers, sterically hindered nitroxyl radicals, butylated hydroxytoluene (BHT), hydroxyhydrocinnamite, thiodipropinoate, phosphites, and combinations thereof.

The sterically hindered nitroxyl ether may have a structure represented by either formula (I), where n is a number from 1 to 10 and each instance of R¹ is independently C₁-C₁₀ alkyl, such as methyl, ethyl, propyl, butyl, pentyl.

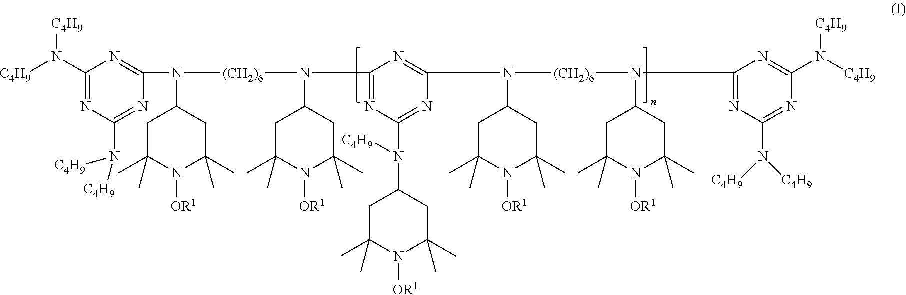

The sterically hindered nitroxyl radical can have the structure represented by the formula (II), where n is a number from 1 to 10.

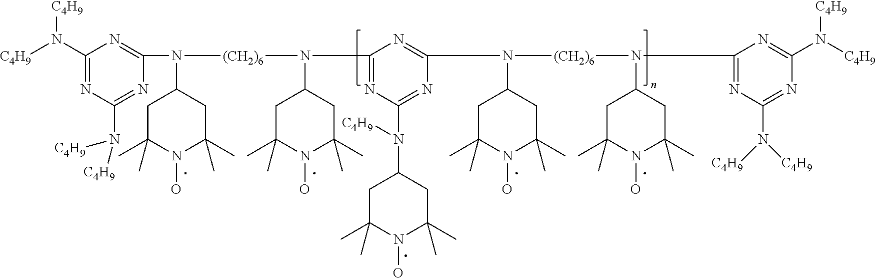

Commercially available examples of structure III stabilizers that can be added during the preparation of halobutyl rubbers of the present disclosure include, but are not limited to, TEMPO, Tinuvin™ NOR 371, Irganox PS 800, Irganox 1035, Irganox 1010, Irganox 1076, Irgafos 168. TEMPO is a term generally used to refer to (2,2,6,6-tetramethylpiperidin-1-yl)oxy. The sterically hindered nitroxyl radical may be TEMPO. Tinuvin™ NOR 371 may be used which is a high molecular weight hindered amine NOR stabilizer, commercially available from BASF as a plastic additive. Irganox PS 800 may be used, which is commercially available from CIBA and is the trade name of didodecyl-3,3′-thiodipropionate. Irganox 1035 may be used and is commercially available from CIBA/BASF and is the trade name of thiodiethylene bis(3,5-di-tert-butyl-4-hydroxyhydrocinnamate). Irganox 1010 may be used which is commercially available from BASF and is the trade name of pentaerythritol tetrakis(3-(3,5-di-tert-butyl-4-hydroxyphenyl) propionate). Irganox 1076 may be used which is commercially available from CIBA and is the trade name of octadecyl-3-(3,5-di-tert.butyl-4-hydroxyphenyl)-propionate. Sterically hindered phenolics may include BHT, Irganox PS 800, Irganox 1035, or combinations thereof. Irgafos 168 may be used which is commercially available from BASF and is a general purpose phosphite. In some embodiments, other structure III stabilizers may be added to the bromobutyl-rubber of the present disclosure including, but not limited to, light stabilizers and UV-absorbers.

In an embodiment, the structure III stabilizer may be added in more than one location in the halogenation process.

In some embodiments, the total amount of structure III stabilizer to be added during the process of preparing the halobutyl rubber is greater than about 20 ppm, such as greater than 50 ppm, such as greater than 75 ppm, such as greater than 100 ppm, to less than about 500 ppm, such as less than about 400 ppm, such as less than about 300 ppm, such as less than about 200 ppm, such as less than about 150 ppm, such as less than about 100 ppm. The ppm weight basis is the weight relative to the halobutyl rubber (whether in solution, slurry, or recovered).

### Finishing

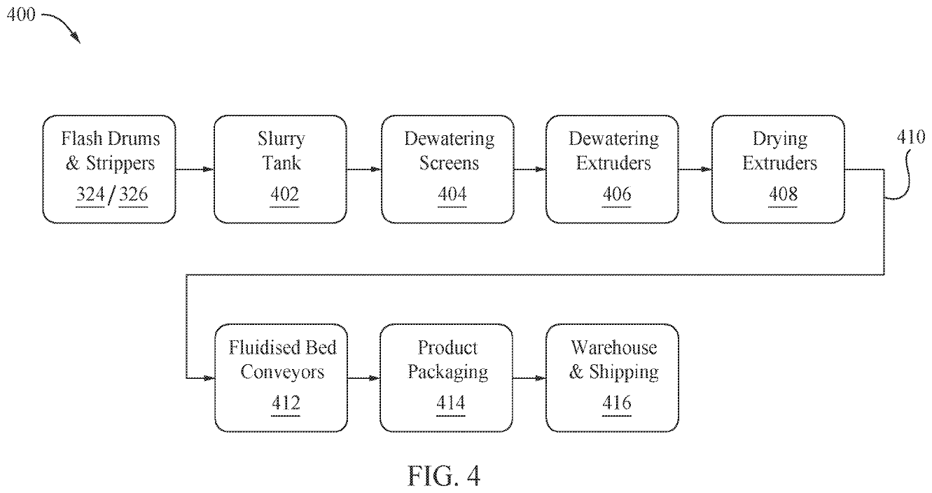

The bottoms stream at 334 from the stripper(s) containing rubber crumb and water is routed to an agitated slurry tank 402, as shown in FIG. 4. FIG. 4 is a diagram 400 illustrating finishing of the crumbs. Typically pitched blade impellors or a combination of pitched blade impellors and flat blade impellors in up or downpumping mode are used.

The rubber crumb/water slurry is pumped to a dewatering screen(s) 404 to remove gross water. The rubber crumb is then fed to 2-3 extruders in series to dewatering extruder 406 and drying extruder 408 the rubber crumb. The dewatering/first stage drying extruders 406, 408 may be one or more of the following: expanders, expellers, dewatering extruders, slurry dewatering units, volatiles control unit. The final stage drying extruders may be dual worm drying extruders, e.g., as described in U.S. Pat. No. 7,858,735 incorporated by reference herein. The temperatures and pressures in the extruders are controlled by adjusting the restriction at the extruder outlet typically with a fixed or variable die plate. Heat may be added by steam jacketing the extruders. Inert gas may be injected to improve drying, as described in U.S. Pat. No. 4,508,592 incorporated herein by reference. Polymer additives are injected at various stages of the extrusion process to meet product specifications and depending on the grade may consist of none, one, or more of the following polymer additives: epoxidized soy bean oil, calcium stearate butylated hydroxytoluene, Irganox, or antioxidants.

The crumbs from the final drying extruder are then transported (line 410) to a fluidized bed conveyor 412 for drying to product specification, the rubber crumb may be transported by mechanical conveyors. In some embodiments, the fluidized bed conveyor 412 has 2 sections consisting of a primary hot section for drying the crumbs and secondary cool section to cool the crumbs. The crumbs from the fluidized bed conveyor 412 are then routed to a packaging unit 414 where the crumb is compacted into bales, packaged and quality checked. The final rubber polymer product at 416 is stored in warehouse for distribution to customers. Large production facilities operate multiple extrusion and fluidized bed drying lines in parallel. The solvent vapors from the slurry tank, the extruders and fluidized bed conveyors may be captured in an air collection system for treatment.

Rubber fines are removed from finishing water recovered from the dewatering screens and extruders for recycle or disposal. The finishing water with fines removed is recycled to the reslurry and halogenation unit with excess water purged from the process. The excess water will be further treated at the facility before final disposal. Additional antifouling and additives may be added to the recycled water to reduce fouling and control pH. The additives may include but not exclusively none, one or more of: calcium chloride, proprietary antifoulants, e.g. PETROFLO™ or borate based buffers.

For some embodiments involving halogen regeneration, additives, including epoxidized soybean oil (also referred to as ESBO) and calcium stearate, may be added during the regenerative process. For example, ESBO may be added in the range of about 1 to about 2 phr in drying extruder 408 before or during the drying. Additionally or alternatively, as described above, calcium stearate may be added to the cement to the second neutralization unit 316, and/or may be added to the flash drum 324 to help the polymer from sticking to the equipment and to control the rubber particle size in the water slurry, and/or may be added to drying extruder 408 during the drying.

In some embodiments, an additive, such as ESBO, may be added to stripper 338 and/or line 334.

### Recycle Stream Driers

The diluent/monomers recycle stream (line 240 of FIG. 2) from the solvent replacement process section is dried using a combination of fixed bed alumina and chloride resistant molecular sieve driers 242 to remove moisture. The alumina driers will also remove oxygenates. The alumina and molecular sieve driers may be operated in series or in parallel or a combination of both, for example the operation is parallel molecular sieve driers with an alumina drier in series. The fixed bed alumina and chloride resistant molecular sieve driers 242 are taken out of service for regeneration when their water hold up capacity or oxygenate hold up capacity has been reached. The regeneration can include 1-3 depressurizations to deep vacuum to recover the hydrocarbon from the bed. The regeneration can include 1-3 warm pressurizations and depressurizations to maximize hydrocarbon removal before full regeneration. The regeneration can be carried out at 240° C. to 300° C. for molecular sieve driers and 190° C. to 250° C. for alumina driers. The regeneration gas humidity can be controlled by cooling the stream and removing moisture with refrigerated heat exchangers in advance of heating. The regeneration will include a steaming stage to minimize oil make up from the process for molecular sieves.

Recovery and Recycle of Monomers from Isobutylene-Based Polymers Using Distillation Processes

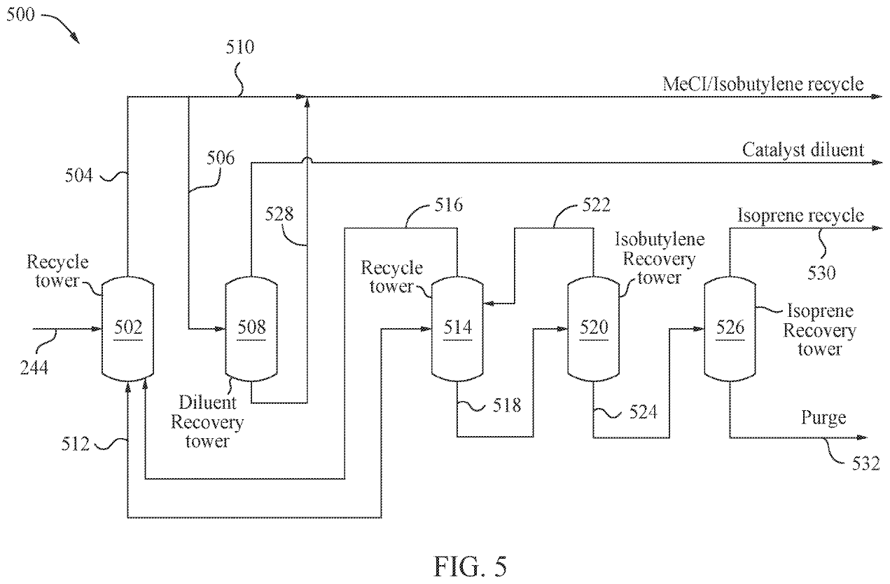

The diluent/monomers stream (244 of FIG. 2) is sent to recycle towers to separate and recover diluent and monomers for reuse in the process. FIG. 5 is a diagram 500 illustrating recycle and recovery of diluent and monomers. As shown in FIG. 5, first recycle tower 502 may be a single tower or 2 separate towers. The first recycle tower(s) 502 recover diluent and isobutylene in the overheads stream 504. The overheads stream is split with a portion (line 506) sent to a diluent recovery tower 508 where high purity diluent is recovered for use as catalyst diluent and a portion sent for recycle. The bottoms 528 of the diluent recovery tower 508 is combined with the other portion (line 510) of the recycle tower overheads and recycled to feed blend. The bottoms 512 of the first recycle tower 502 is sent to a second recycle tower 514. Overheads 516 of the second recycle tower are sent to diluent recovery tower 508. Bottoms 518 of the second recycle tower 514 containing isobutylene, isoprene, and some heavies is sent to an isobutylene recovery tower 520 where isobutylene is recovered overhead (line 522) for recycle. The bottoms 524 of the isobutylene recovery tower 520 is sent to an isoprene recovery tower 526 where isoprene is recovered overhead 530 for recycle. The bottoms 532 of the isoprene recovery tower 526 is purged from the process. The isobutylene and the isoprene recovery tower may be combined into a single distillation column. The distillate drum on the diluent recovery tower 508 can have an inerts venting system. This inerts venting system recovers diluent from the inerts stream and vents the residual ethylene/ethane by product from the aluminum alkyl catalyst and inerts from the process. The inerts recovery system has a distillation tower or a series of refrigeration heat exchangers to recover diluent.

Antifoulants are injected into the isobutylene recovery tower 520 and isoprene recovery tower 526 to minimize fouling. Antifoulants may include a structure III stabilizer of the present disclosure and/or one or more suitable other antioxidants or antifoulants, including but not exclusively BHT (butylated hydroxytoluene) and proprietary antifoulants, e.g. PETROFLO™. The isoprene recovery tower 526 trays and isobutylene recovery tower 520 trays may be electropolished to minimize fouling. Oxygen analyzers are fitted in the second recycle tower 514 overhead and diluent recovery tower 508 overhead.

In some embodiments, concentration of isobutylene in the diluent recovery tower 508 overheads used for catalyst diluent is <50 wtppm isobutylene and such as <20 wtppm isobutylene. The recycle tower/diluent recovery tower temperatures can be set by the utilities temperature on the overhead condensers, typically cooling water or air. The tower pressures are set by the stream compositions based on the vapor pressure curves at the tower operating temperature. The second recycle tower 514 pressure can be about 800 kPag to about 1200 kPag, such as about 1000 kPag to about 1200 kPag. The diluent recovery tower 508 operating pressures can be about 800 kPag to about 1200 kPag, such as about 1000 kPag to about 1200 kPag. The isobutylene recovery tower 520 can use refrigerant in an overhead condenser to set a tower operating pressure of about 150 kPag to about 250 kPag. The isoprene recovery tower 526 can use refrigerant or cooling water in an overhead condenser and operates at a pressure of about 50 kPaa to about 150 kPaa to minimize fouling. The second recycle tower 514 and isobutylene recovery tower 520 can recover about 95% to about 99.999%, such as about 99.8 to about 99.9%, of the isobutylene in the feed. The isobutylene composition in the recycle streams is set by the reactor conversion.

### Additional Aspects

The present disclosure provides, among others, the following aspects, each of which may be considered as optionally including any alternate aspects.

Clause 1. A method of forming a halobutyl elastomer, comprising:
polymerizing, in a first reactor, a C₄ to C₇ isomonoolefin, and at least one comonomer to obtain a C₄ to C₇ isomonoolefin derived elastomer;
transferring, via a line, the C₄ to C₇ isomonoolefin derived elastomer to a second reactor;
introducing the C₄ to C₇ isomonoolefin derived elastomer with about 20 ppm to about 400 ppm of a structure III stabilizer, based on an amount of C₄ to C₇ isomonoolefin derived elastomer and the structure III stabilizer; and
introducing the C₄ to C₇ isomonoolefin derived elastomer with a halogenating agent to form the halobutyl elastomer.

Clause 2. The method of Clause 1, wherein introducing the C₄ to C₇ isomonoolefin derived elastomer with the structure III stabilizer is performed with about 75 ppm to about 150 ppm of the structure III stabilizer, based on the amount of C₄ to C₇ isomonoolefin derived elastomer and the structure III stabilizer.

Clause 3. The method of Clauses 1 or 2, wherein introducing the C₄ to C₇ isomonoolefin derived elastomer with the structure III stabilizer is performed in the line transferring the C₄ to C₇ isomonoolefin derived elastomer to the second reactor.

Clause 4. The method of any of Clauses 1 to 3, wherein introducing the C₄ to C₇ isomonoolefin derived elastomer with the structure III stabilizer is performed in the second reactor.

Clause 5. The method of any of Clauses 1 to 4, wherein introducing the C₄ to C₇ isomonoolefin derived elastomer with the halogenating agent is performed in the second reactor.

Clause 6. The method of any of Clauses 1 to 5, wherein introducing the C₄ to C₇ isomonoolefin derived elastomer with the halogenating agent further comprises introducing the C₄ to C₇ isomonoolefin derived elastomer and the halogenating agent with an emulsion comprising an oxidizing agent, water, a solvent, and a surfactant.

Clause 7. The method of any of Clauses 1 to 6, wherein the halogenating agent is Br₂.

Clause 8. The method of any of Clauses 1 to 7, wherein the structure III stabilizer is selected from the group consisting of a nitroxyl ether, a nitroxyl radical, a phenol, a phosphite, and combinations thereof.

Clause 9. The method of any of Clauses 1 to 8, wherein the halobutyl elastomer has:
about 0.7 mol % to about 0.9 mol % structure II units; and
about 0.03 mol % to about 0.15 mol % structure III units.

Clause 10. The method of any of Clauses 1 to 9, wherein the halobutyl elastomer has:
about 0.6 mol % to about 0.9 mol % structure II units; and
about 0.05 mol % to about 0.1 mol % structure III units.

Clause 11. The method of any of Clauses 1 to 10, further comprising providing an effluent of the second reactor to a first neutralization unit and providing a neutralizing agent and water to the first neutralization unit.

Clause 12. The method of any of Clauses 1 to 11, further comprising providing an effluent of the first neutralization unit to a second neutralization unit and providing a salt of stearic acid to the second neutralization unit.

Clause 13. The method of any of Clauses 1 to 12, further comprising providing an effluent of the second neutralization unit to a flash drum and introducing calcium stearate and steam to the flash drum.

Clause 14. The method of any of Clauses 1 to 13, further comprising providing an effluent of the flash drum to a stripper vessel and introducing steam to the stripper vessel.

Clause 15. The method of any of Clauses 1 to 14, further comprising spraying water into a vapor space of each of the flash drum and the stripper vessel.

Clause 16. The method of any of Clauses 1 to 15, wherein introducing the C₄ to C₇ isomonoolefin derived elastomer with the halogenating agent is performed at a temperature of about 40° C. to about 60° C.

Clause 17. The method of any of Clauses 1 to 16, further comprising operating the flash drum at a pressure of about 140 kPaa to about 190 kPaa and a liquid temperature of about 105° C. to about 120° C.

Clause 18. The method of any of Clauses 1 to 17, further comprising operating the stripper vessel at a pressure of about 90 kPaa to about 120 kPaa and a liquid temperature of about 90° C. to about 110° C.

Clause 19. The method of any of Clauses 1 to 18, wherein the C₄ to C₇ isomonoolefin is isobutylene.

Clause 20. The method of any of Clauses 1 to 19, wherein the at least one comonomer is isoprene.

Clause 21. The method of any of Clauses 1 to 20, wherein:
introducing the C₄ to C₇ isomonoolefin derived elastomer with the structure III stabilizer is performed in the line transferring the C₄ to C₇ isomonoolefin derived elastomer to the second reactor; and
the halobutyl elastomer has:
   about 0.7 mol % to about 0.9 mol % structure II units; and
   about 0.03 mol % to about 0.15 mol % structure III units.

Clause 22. The method of any of Clauses 1 to 21, wherein introducing the C₄ to C₇ isomonoolefin derived elastomer with the structure III stabilizer is performed with about 75 ppm to about 150 ppm of the structure III stabilizer, based on the amount of C₄ to C₇ isomonoolefin derived elastomer and the structure III stabilizer.

Clause 23. The method of any of Clauses 1 to 22, wherein the halobutyl elastomer has:
about 0.6 mol % to about 0.9 mol % structure II units; and
about 0.05 mol % to about 0.1 mol % structure III units.

Clause 24. The method of any of Clauses 1 to 23, wherein the halobutyl elastomer has about 15 ppm or less of structure III stabilizer content, such as about 10 ppm or less, such as about 7 ppm or less.

### EXAMPLES

A BHT injection point into a cement line immediately before the halogenation reactor, upstream of the halogenation reactor. This can be used to inject a small amount of BHT to keep the background levels up (below a maximum spec). The injection had a control valve and was tested and proven to control at a desired flow rate to maintain stable low levels of BHT to promote the structure 2 formation of bromobutyl rubber. This would maintain uniform structures during the production of Irganox grade rubber and therefore desirable finished rubber properties. As used herein, an “Irganox grade rubber” refers to a grade of rubber where the primary antioxidant used is Irganox. It was discovered that processes of the present disclosure can provide pharmaceutical grade runs, with less off grade, more uniform product. Pharmaceutical grade polymers are typically completed after an extensive cleaning of a finishing building and are produced no more than two weeks after the cleaning.

Irganox grades were studied and the structure 3 was plotted against BHT in finished rubber using a lab test method.

The first step was to test the control of the BHT on normal grades. Once we understood and checked the response of the control valve, and confirmed the required flow rate of BHT, then BHT was injected on a mass balance basis on the following Irganox run, backed up with the test.

This process control with lab feedback loop should allow more stable Irganox grade rubber to be manufactured, potentially with longer pharmaceutical grade runs as the halobutyl rubber that forms is not hindered by structure 3 formation.

The addition of the BHT after the control valve was measured in the finished rubber using Gas Chromatography, and the structure 3 was measured using Fourier-transform infrared (FTIR) spectroscopy.

For calculating the amount of BHT in the rubber, a known amount of Butyl rubber sample was disscolved in Hexane. Once it was fully dissolved, acetone was added to precipitate the polymer and this was stirred until a clear solution was obtained. The solution was then filtered and a GC (gas chromatography) vial was filled. The GC method was developed using an Agilent 9000 GC with split injection and a repeatable temperature ramp. The GC sample was then detected in a FID detector. The area of the peak was compared to known amounts of BHT previously injected using the same conditions. The GC conditions were as follows:
Inlet (Split/Splitless):
   Carrier Gas: Hydrogen
   Make up Gas: Nitrogen
   Make up Flow: 25 ml/min
   Temperature: 300° C.
   Injection Size 2 μl (using 5 μl syringe)
   Injection Mode: Split
Oven Program:
   Initial Temperature: 120° C.
   Rate (ramp 1): 30° C./min
   Time 1:1 min
   Final Temperature: 220° C.
   Total Run Time: 5 min
Column Program:
   Constant Flow: 15 ml/min
   Pressure: 14.43 Psi
Detector Temperature: 300° C.
Column is a 30 m×0.32 mm id×1 μm DB-FFAP capillary column.

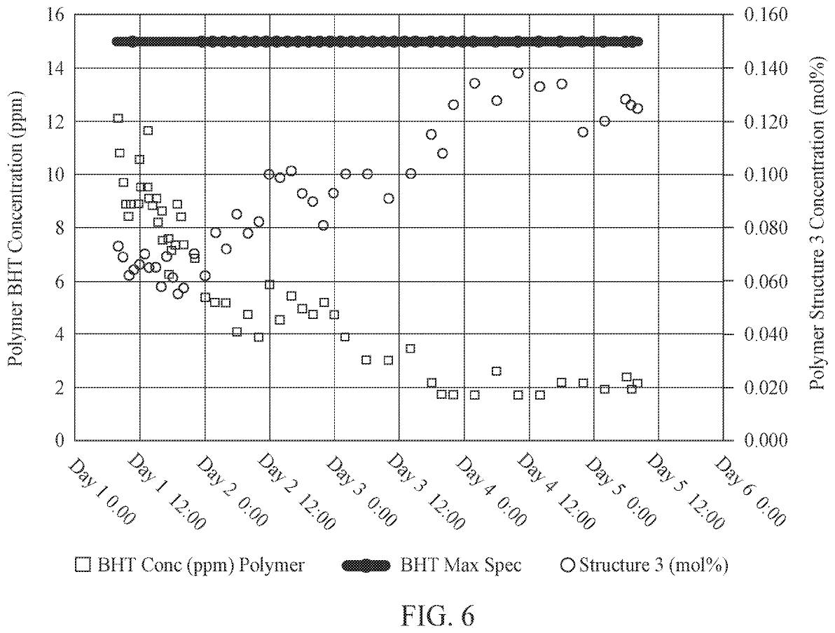

Table 1 shows the results of the ppm BHT from the rubber and the corresponding structure 3 content, as plotted in FIG. 6.

TABLE 1
BHT in Halogenated Butyl rubber where Irganox
is the primary structure stabilizer

| | BHT Conc (ppm), | Structure 3 |
|---|---|---|
| Sample Time | polymer | (mol %) |
| Day 1 08:00 | 12 | 0.073 |
| Day 1 08:30 | 11 | |
| Day 1 09:00 | 10 | 0.069 |
| Day 1 09:30 | 9 | |
| Day 1 10:00 | 8 | 0.062 |
| Day 1 10:30 | 9 | |
| Day 1 11:00 | 9 | 0.064 |
| Day 1 11:30 | 9 | |
| Day 1 12:00 | 11 | 0.066 |
| Day 1 12:30 | 9 | |
| Day 1 13:00 | 9 | 0.070 |
| Day 1 13:30 | 12 | |
| Day 1 14:00 | 9 | 0.065 |
| Day 1 14:30 | 9 | |
| Day 1 15:00 | 9 | 0.065 |
| Day 1 15:30 | 8 | |
| Day 1 16:00 | 9 | 0.058 |
| Day 1 16:30 | 8 | |
| Day 1 17:00 | 8 | 0.069 |
| Day 1 17:30 | 6 | |
| Day 1 18:00 | 7 | 0.061 |
| Day 1 18:30 | 7 | |
| Day 1 19:00 | 9 | 0.055 |
| Day 1 19:30 | 8 | |
| Day 1 20:00 | 7 | 0.057 |
| Day 1 22:00 | 7 | 0.070 |
| Day 2 00:00 | 5 | 0.062 |
| Day 2 02:00 | 5 | 0.078 |
| Day 2 04:00 | 5 | 0.072 |
| Day 2 06:00 | 4 | 0.085 |
| Day 2 08:00 | 5 | 0.078 |
| Day 2 10:00 | 4 | 0.082 |
| Day 2 12:00 | 6 | 0.100 |
| Day 2 14:00 | 5 | 0.099 |
| Day 2 16:00 | 5 | 0.101 |
| Day 2 18:00 | 5 | 0.093 |
| Day 2 20:00 | 5 | 0.090 |
| Day 2 22:00 | 5 | 0.081 |
| Day 3 00:00 | 5 | 0.093 |
| Day 3 02:00 | 4 | 0.100 |
| Day 3 06:00 | 3 | 0.100 |
| Day 3 10:00 | 3 | 0.091 |
| Day 3 14:00 | 3 | 0.100 |
| Day 3 18:00 | 2 | 0.115 |
| Day 3 20:00 | 2 | 0.108 |
| Day 3 22:00 | 2 | 0.126 |
| Day 4 02:00 | 2 | 0.134 |
| Day 4 06:00 | 3 | 0.128 |
| Day 4 10:00 | 2 | 0.138 |
| Day 4 14:00 | 2 | 0.133 |
| Day 4 18:00 | 2 | 0.134 |
| Day 4 22:00 | 2 | 0.116 |
| Day 5 02:00 | 2 | 0.120 |
| Day 5 06:00 | 2 | 0.128 |
| Day 5 07:00 | 2 | 0.126 |
| Day 5 08:00 | 2 | 0.125 |

A second test was performed where the control valve was opened during the grade and the subsequent BHT and structure 3 was measured. The result was a more controlled rise in structure 3 formation which resulted in a stable structure 3 at a lower limit than without BHT addition. The reduction in structure 3 results in an increase in the validity of the functional bromine model, where we have typically been before the addition of the BHT at bromination reactors where there is potential the high structure 3 formation would reduce the accuracy of the functional bromine prediction (which is based on Macro development described below). This trial was completed with a manufacturing specification and a safety factor applied so the FCV566 was throttled in. However, there were still promising results including finishability of the rubber towards the end of the run, which is otherwise typically poor. The background BHT within the hexane system will have a cumulative effect over time which presents its self as an opportunity to have a secondary effect on structure 3 but will need to be carefully balanced with the flow from FCV566.

The functional bromine model is created using FTIR data and NMR data and is a specification on rubber. Macros are developed by Technology using Perkin Elmer software and sent to the participating plants to test the sample. This software is used to determine the mol % of each property.

TABLE 2
BHT in Halogenated Butyl rubber (where Irganox is the primary
structure stabilizer) after addition before bromination reactor

| | BHT Conc (ppm), | Structure 3 |
|---|---|---|
| Sample Time | polymer | (mol %) |
| Day 1 01:00 | 6.5 | 0.057 |
| Day 1 02:00 | 6.3 | 0.053 |
| Day 1 04:00 | 5.8 | 0.051 |
| Day 1 06:00 | 5.8 | 0.064 |
| Day 1 10:00 | 6.5 | 0.056 |
| Day 1 14:00 | 5 | 0.069 |
| Day 1 18:00 | 4.7 | 0.068 |
| Day 1 22:00 | 3.2 | 0.076 |
| Day 2 02:00 | 3.5 | 0.066 |
| Day 2 06:00 | 4.1 | 0.077 |
| Day 2 10:00 | 3.2 | 0.083 |
| Day 2 14:00 | 3.9 | 0.092 |
| Day 2 18:00 | 3.2 | 0.088 |
| Day 2 22:00 | 2.4 | 0.099 |
| Day 3 02:00 | 1.7 | 0.097 |
| Day 3 06:00 | 3 | 0.106 |
| Day 3 10:00 | 3 | 0.119 |
| Day 3 12:00 | 2.8 | 0.118 |
| Day 3 14:00 | 2.8 | 0.115 |
| Day 3 18:00 | 2.2 | 0.096 |
| Day 3 22:00 | 3.7 | 0.101 |
| Day 4 02:00 | 1.7 | 0.112 |
| Day 4 06:00 | 3.9 | 0.099 |
| Day 4 10:00 | 3.9 | 0.089 |
| Day 4 13:00 | 4.7 | 0.104 |
| Day 4 14:00 | 3.5 | 0.107 |

It was discovered that when bromination is carried out in presence of the antioxidant, it is possible to reduce the amount of structure 3 formation, which is detrimental to the reactivity and marching Mooney properties of the halobutyl rubber.

It was observed that having a certain amount of BHT (~80-100 ppm) injected at a point upstream of bromination, upstream of where the 35% peroxide was injected, and upstream of the caustic addition for neutralization, showed low structure III (see Table 3). High structure III present in the bromobutyl product can be undesirable, due its high reactivity, results in high marching Mooney (Mooney change) with storage, low shelf stability, scorch behavior (see Table 4), increased cure speed in compounds (see Table 5)

The addition of BHT prior to bromination reduces the free radical bromination which lead to the formation of structure III. Reduced levels of structure III, and an additional amount of BHT added into the neutralized cement after bromination, prior to the heat history associated with the finishing steps, inhibits the polymeric network that forms from thermo-oxidative crosslinking, and consequently reduces the warehouse Mooney growth and reduced scorch and cure speed of the compounds.

TABLE 3
Bromobutyl structural data by NMR and FTIR

| | | | Regen | | | | | | |
|---|---|---|---|---|---|---|---|---|---|
| | | | (R)/ | | | | III | III | NMR |
| | | | Conv. | | I | | endo, | exo, | Total |
| Ex. | | Run Conditions | (C) | I | minor | St II | Z | E | III |
| 1 | 1A | Pre-trial control, 27 | C | 0.323 | 0.133 | 0.798 | 0.037 | 0.024 | 0.061 |
| | | klb/hr cemflow, | | | | | | | |
| | | two Reslurry Trains | | | | | | | |
| 2 | 3C | 0.5 molar ratio | R | 0.262 | 0.137 | 0.899 | 0.057 | 0.037 | 0.094 |
| | | H₂O₂, low rate 13.5 | | | | | | | |
| | | klb/hr cemflow, no | | | | | | | |
| | | BHT, one Reslurry | | | | | | | |
| | | Train | | | | | | | |
| 3 | 3F | 0.5 molar ratio | R | 0.279 | 0.13 | 0.892 | 0.069 | 0.043 | 0.112 |
| | | H₂O₂, low rate 13.4 | | | | | | | |
| | | klb/hr cemflow, no | | | | | | | |
| | | BHT, one Reslurry | | | | | | | |
| | | Train | | | | | | | |
| 4 | 5A | 0.5 molar ratio | R | 0.271 | 0.124 | 0.904 | 0.045 | 0.027 | 0.072 |
| | | H₂O₂, low rate 13.5 | | | | | | | |
| | | klb/hr cemflow, | | | | | | | |
| | | ~800 wppm BHT, | | | | | | | |
| | | one Reslurry Train | | | | | | | |
| 5 | 5C | 0.5 molar ratio | R | 0.274 | 0.132 | 0.874 | 0.051 | 0.034 | 0.085 |
| | | H₂O₂, low rate 13.4 | | | | | | | |
| | | klb/hr cemflow, | | | | | | | |
| | | ~800 wppm BHT, | | | | | | | |
| | | one Reslurry Train | | | | | | | |

| | | | | II + | Structures |
|---|---|---|---|---|---|
| Ex. | | Run Conditions | St IV | III + IV | (Total) |
| 1 | 1A | Pre-trial control, 27 | 0.069 | 0.927 | 1.416 |
| | | klb/hr cemflow, | | | |
| | | two Reslurry Trains | | | |
| 2 | 3C | 0.5 molar ratio | 0.079 | 1.072 | 1.524 |
| | | H₂O₂, low rate 13.5 | | | |
| | | klb/hr cemflow, no | | | |
| | | BHT, one Reslurry | | | |
| | | Train | | | |
| 3 | 3F | 0.5 molar ratio | 0.084 | 1.088 | 1.54 |
| | | H₂O₂, low rate 13.4 | | | |
| | | klb/hr cemflow, no | | | |
| | | BHT, one Reslurry | | | |
| | | Train | | | |
| 4 | 5A | 0.5 molar ratio | 0.063 | 1.039 | 1.477 |
| | | H₂O₂, low rate 13.5 | | | |
| | | klb/hr cemflow, | | | |
| | | ~800 wppm BHT, | | | |
| | | one Reslurry Train | | | |
| 5 | 5C | 0.5 molar ratio | 0.068 | 1.027 | 1.481 |
| | | H₂O₂, low rate 13.4 | | | |
| | | klb/hr cemflow, | | | |
| | | ~800 wppm BHT, | | | |
| | | one Reslurry Train | | | |

TABLE 4
Innerliner compound Mooney scorch properties

| | | | | Mooney | | | Mooney | | |
|---|---|---|---|---|---|---|---|---|---|
| | | | | Scorch on | | | Scorch on | | |
| | | | | MV2000, | | | MV2000, | | |
| | | | ML | 125 | | | 135C | | |
| Sample | Mm | tMm | (1 + 4) | t5 | t10 | t35 | t5 | t10 | t35 |
| Description | [MU] | [min] | [MU] | [min] | [min] | [min] | [min] | [min] | [min] |
| BIIR 2255-2C | 53.1 | | 54.0 | 34.1 | 38.9 | 46.0 | 16.7 | 19.2 | 22.7 |
| (pre-control) | | | | | | | | | |
| BIIR 2255-3B | 53.7 | | 54.7 | 30.8 | 35.1 | 41.3 | 15.3 | 17.5 | 20.6 |
| (BrRegen-0.5 | | | | | | | | | |
| mol, low rate) | | | | | | | | | |
| BIIR 2255-5A | 53.1 | | 54.0 | 32.3 | 36.5 | 42.8 | 16.0 | 18.3 | 21.3 |
| (BrRegen-0.5 | | | | | | | | | |
| mol + BHT) | | | | | | | | | |
| BIIR 2255-11B | 53.4 | | 54.2 | 34.3 | 38.9 | 46.1 | 16.8 | 19.2 | 22.8 |
| (BT typical) | | | | | | | | | |

TABLE 5
Innerliner compound cure properties

| | | | MH- | | | | | | Peak |
|---|---|---|---|---|---|---|---|---|---|
| Sample | ML | MH | ML | ts2 | t10 | t50 | t90 | Peak Rate | Time |
| Description | [dNm] | [dNm] | [dNm] | [min] | [min] | [min | [min] | [dNm/min] | [min] |
| | MDR, | | | | | | | | |
| | 160C | | | | | | | | |
| BIIR 2255-2C | 1.7 | 5.3 | 3.7 | 5.9 | 2.2 | 5.6 | 9.5 | 0.59 | 4.9 |
| (pre-control) | | | | | | | | | |
| BIIR 2255-3B | 1.7 | 5.3 | 3.6 | 5.2 | 2.1 | 4.9 | 8.2 | 0.74 | 4.4 |
| (BrRegen-0.5 | | | | | | | | | |
| mol, low rate) | | | | | | | | | |
| BIIR 2255-5A | 1.6 | 5.3 | 3.7 | 5.2 | 2.2 | 5.0 | 8.4 | 0.73 | 4.4 |
| (BrRegen-0.5 | | | | | | | | | |
| mol + BHT) | | | | | | | | | |
| BIIR 2255-11B | 1.7 | 5.4 | 3.7 | 5.7 | 2.1 | 5.4 | 9.3 | 0.60 | 4.9 |
| (BT typical) | | | | | | | | | |
| | MDR, | | | | | | | | |
| | 180C | | | | | | | | |
| BIIR 2255-2C | 1.4 | 4.9 | 3.5 | 1.9 | 0.9 | 1.8 | 2.7 | 2.1 | 1.6 |
| (pre-control) | | | | | | | | | |
| BIIR 2255-3B | 1.5 | 5.1 | 3.7 | 1.7 | 0.9 | 1.6 | 2.5 | 2.5 | 1.6 |
| (BrRegen-0.5 | | | | | | | | | |
| mol, low rate) | | | | | | | | | |
| BIIR 2255-5A | 1.4 | 4.9 | 3.5 | 1.8 | 0.9 | 1.7 | 2.6 | 2.3 | 1.6 |
| (BrRegen-0.5 | | | | | | | | | |
| mol + BHT) | | | | | | | | | |
| BIIR 2255-11B | 1.5 | 5.0 | 3.5 | 1.9 | 0.9 | 1.8 | 2.8 | 2.0 | 1.6 |
| (BT typical) | | | | | | | | | |

TABLE 6
Innerliner compound physical properties

| | | | | Original | | | | | |
|---|---|---|---|---|---|---|---|---|---|
| | | Aged, | | | | | Tensile | | |
| | | 125° C., | Green | 100% | 200% | 300% | Strength | Elongation | Energy@ |
| Sample | Original | 72 hrs. | Strength | mod | mod | mod | @ break | @break | break |
| Description | [Shore A] | [Shore A] | [N/mm2] | [MPa] | [MPa] | [MPa] | [MPa] | [%] | [J] |
| BIIR 2255-2C | 42 | 52 | 0.21 | 0.9 | 1.9 | 3.2 | 9.1 | 800 | 10.8 |
| (pre-control) | | | | | | | | | |
| BIIR 2255-3B | 42 | 51 | 0.23 | 1.0 | 2.0 | 3.3 | 8.7 | 770 | 10.4 |
| (BrRegen-0.5 | | | | | | | | | |
| mol, low rate) | | | | | | | | | |
| BIIR 2255-5A | 41 | 51 | 0.23 | 0.9 | 2.0 | 3.3 | 8.8 | 790 | 10.8 |
| (BrRegen-0.5 | | | | | | | | | |
| mol + BHT) | | | | | | | | | |
| BIIR 2255-11B | 41 | 51 | 0.23 | 0.9 | 2.0 | 3.3 | 8.8 | 780 | 10.3 |
| (BT typical) | | | | | | | | | |

Aged, 125° C., 72 hrs.

| | | Aged, | | | | | Tensile | Elongation | Energy |
|---|---|---|---|---|---|---|---|---|---|
| | | 125° C., | Green | 100% | 200% | 300% | Strength | @ | @ |
| Sample | Original | 72 hrs. | Strength | mod | mod | mod | @ break | break | break |
| Description | [Shore A] | [Shore A] | [N/mm²] | [MPa] | [MPa] | [MPa] | [MPa] | [%] | [J] |
| BIIR 2255-2C | 42 | 52 | 0.21 | 1.7 | 3.5 | 5.0 | 7.0 | 580 | 7.8 |
| (pre-control) | | | | | | | | | |
| BIIR 2255-3B | 42 | 51 | 0.23 | 1.9 | 3.8 | 5.4 | 7.1 | 530 | 7.3 |
| (BrRegen-0.5 | | | | | | | | | |
| mol, low rate) | | | | | | | | | |
| BIIR 2255-5A | 41 | 51 | 0.23 | 1.8 | 3.7 | 5.2 | 6.9 | 530 | 7.1 |
| (BrRegen-0.5 | | | | | | | | | |
| mol + BHT) | | | | | | | | | |
| BIIR 2255-11B | 41 | 51 | 0.23 | 1.8 | 3.7 | 5.2 | 6.9 | 530 | 7.0 |
| (BT typical) | | | | | | | | | |

Overall, the present disclosure provides methods for halobutyl rubber formation using a structure III stabilizer (such as butylated hydroxytoluene) that can be introduced to the halogenation process upstream of the halogenation reactor (or in the halogenation reactor), which has been discovered to provide halobutyl rubber having high structure 2 content at a higher yield than conventional processes and provides an option to perform bromine regeneration without marching Mooney. Such structure III stabilizers can be provided upstream of a halogenation reactor (or in the halogenation reactor) in amounts that are less than those of conventional uses of BHT in halobutyl processes.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All numerical values within the detailed description herein are modified by “about” the indicated value, and take into account experimental error and variations that would be expected by a person having ordinary skill in the art.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having benefit of this disclosure, will appreciate that other embodiments can be devised which do not depart from the scope and spirit of the present disclosure.

We claim:

1. A method of forming a halobutyl elastomer, comprising:
polymerizing, in a first reactor, a C₄ to C₇ isomonoolefin, and at least one comonomer to obtain a C₄ to C₇ isomonoolefin derived elastomer;
transferring, via a line, the C₄ to C₇ isomonoolefin derived elastomer to a second reactor;
introducing the C₄ to C₇ isomonoolefin derived elastomer with about 20 ppm to about 400 ppm of a structure III stabilizer, based on an amount of C₄ to C₇ isomonoolefin derived elastomer and the structure III stabilizer; and
introducing the C₄ to C₇ isomonoolefin derived elastomer with a halogenating agent to form the halobutyl elastomer.

2. The method of claim 1, wherein introducing the C₄ to C₇ isomonoolefin derived elastomer with the structure III stabilizer is performed with about 75 ppm to about 150 ppm of the structure III stabilizer, based on the amount of C₄ to C₇ isomonoolefin derived elastomer and the structure III stabilizer.

3. The method of claim 2, wherein introducing the C₄ to C₇ isomonoolefin derived elastomer with the structure III stabilizer is performed in the line transferring the C₄ to C₇ isomonoolefin derived elastomer to the second reactor.

4. The method of claim 2, wherein introducing the C₄ to C₇ isomonoolefin derived elastomer with the structure III stabilizer is performed in the second reactor.

5. The method of claim 2, wherein introducing the C₄ to C₇ isomonoolefin derived elastomer with the halogenating agent is performed in the second reactor.

6. The method of claim 1, wherein introducing the C₄ to C₇ isomonoolefin derived elastomer with the halogenating agent further comprises introducing the C₄ to C₇ isomonoolefin derived elastomer and the halogenating agent with an emulsion comprising an oxidizing agent, water, a solvent, and a surfactant.

7. The method of claim 1, wherein the halogenating agent is Br₂.

8. The method of claim 1, wherein the structure III stabilizer is selected from the group consisting of a nitroxyl ether, a nitroxyl radical, a phenol, a phosphite, and combinations thereof.

9. The method of claim 1, wherein the halobutyl elastomer has:
about 0.7 mol % to about 0.9 mol % structure II units; and
about 0.03 mol % to about 0.15 mol % structure III units.

10. The method of claim 1, wherein the halobutyl elastomer has:
about 0.6 mol % to about 0.9 mol % structure II units; and
about 0.05 mol % to about 0.1 mol % structure III units.

11. The method of claim 1, further comprising providing an effluent of the second reactor to a first neutralization unit and providing a neutralizing agent and water to the first neutralization unit.

12. The method of claim 11, further comprising providing an effluent of the first neutralization unit to a second neutralization unit and providing a salt of stearic acid to the second neutralization unit.

13. The method of claim 12, further comprising providing an effluent of the second neutralization unit to a flash drum and introducing calcium stearate and steam to the flash drum.

14. The method of claim 13, further comprising providing an effluent of the flash drum to a stripper vessel and introducing steam to the stripper vessel.

15. The method of claim 14, further comprising spraying water into a vapor space of each of the flash drum and the stripper vessel.

16. The method of claim 1, wherein introducing the C₄ to C₇ isomonoolefin derived elastomer with the halogenating agent is performed at a temperature of about 40° C. to about 60° C.

17. The method of claim 15, further comprising operating the flash drum at a pressure of about 140 kPaa to about 190 kPaa and a liquid temperature of about 105° C. to about 120° C.

18. The method of claim 17, further comprising operating the stripper vessel at a pressure of about 90 kPaa to about 120 kPaa and a liquid temperature of about 90° C. to about 110° C.

19. The method of claim 1, wherein the C₄ to C₇ isomonoolefin is isobutylene.

20. The method of claim 19, wherein the at least one comonomer is isoprene.

21. The method of claim 1, wherein:
introducing the C₄ to C₇ isomonoolefin derived elastomer with the structure III stabilizer is performed in the line transferring the C₄ to C₇ isomonoolefin derived elastomer to the second reactor; and
the halobutyl elastomer has:
about 0.7 mol % to about 0.9 mol % structure II units; and
about 0.03 mol % to about 0.15 mol % structure III units.

22. The method of claim 21, wherein introducing the C₄ to C₇ isomonoolefin derived elastomer with the structure III stabilizer is performed with about 75 ppm to about 150 ppm of the structure III stabilizer, based on the amount of C₄ to C₇ isomonoolefin derived elastomer and the structure III stabilizer.

23. The method of claim 22, wherein the halobutyl elastomer has:
about 0.6 mol % to about 0.9 mol % structure II units; and
about 0.05 mol % to about 0.1 mol % structure III units.

24. The method of claim 23, wherein the halobutyl elastomer has about 15 ppm or less of structure III stabilizer content.
